(19) United States
(12) Patent Application Publication
(10) Pub. No.: US 2003/0222751 A1
(43) Pub. Date: Dec. 4, 2003

(54) Coil

(76) Inventors: Toshikazu Fujiyoshi, Osaka-shi (JP); Masao Katooka, Osaka-shi (JP); Tetsuro Ikeda, Osaka-shi (JP); Kenji Morimoto, Osaka-shi (JP); Hideo Ishii, Osaka-shi (JP)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/445,649

(22) Filed: May 27, 2003

(30) Foreign Application Priority Data
May 27, 2002 (JP) 2002-152117

(51) Int. Cl. H01F 5/00

(52) U.S. Cl. 336/200

(57) ABSTRACT

Metallic coils sheets (34, 36, 38) are planar and include center windows (34a, 36a, 38a). Slits (34b, 36b, 38b) extend outward through the respective sheets from the windows. Connection terminals (34c, 34d; 36c, 36d; 38c, 38d) are provided on the sheets at locations facing across the respective slits. The metallic coil sheets are stacked, and adjacent ones of the stacked metallic coil sheets are electrically connected by means of the connection terminals. A core (60, 62) is disposed in the windows of the stacked metallic coil sheets. The metallic coil sheets are individually covered with an insulating coating.

This invention relates to a coil that may be used, for example, as a component of a transformer or as a choke.

### BACKGROUND OF THE INVENTION

The applicant of the present application filed U.S. patent application Ser. No. 10/006,478 on Dec. 6, 2001, entitled “High-Frequency Large Current Handling Transformer”, which was published on Jun. 13, 2002 under US-2002-0070836-A1. The transformer disclosed in the U.S. application includes coil sheets or planar coil members 1, 2, 3, 4, 5 and 6 of metal, e.g. copper, as shown in FIG. 1. The metallic coil sheets 1, 2, 3, 4, 5 and 6 are formed in a rectangular shape with windows 1a, 2a, 3a, 4a, 5a and 6a in their center portions. One side of each coil sheet is cut to form a slit 1b, 2b, 3b, 4b, 5b, 6b therein. Tabs 1c and 1d extend outward from the portions facing across the slit 1b. Similarly, tabs 2c and 2d, 3c and 3d, 4c and 4d, 5c and 5d, and 6c and 6d extend outward from the portions of the respective sheet coils 2, 3, 4, 5 and 6 facing each other across the slits 2b, 3b, 4b, 5b and 6b. The tabs 1c, 2c, 3c, 4c, 5c and 6c provide winding start terminals, while the tabs 1d, 2d, 3d, 4d, 5d and 6d provide winding end terminals. The coil sheets 1, 2 and 3 are stacked, with the tabs 1d and 2c interconnected and with the tabs 2d and 3c interconnected, to thereby provide a primary winding of the transformer. Similarly, the coil sheets 4, 5 and 6 are stacked, with the tabs 4c, 5c and 6c interconnected and with the tabs 4d, 5d and 6d interconnected, to thereby provide a secondary winding. Insulating sheets 9, 10, 11 and 14 are disposed in such a manner that each coil sheets 1, 2 and 3 are sandwiched between two of the insulating sheets. An insulating sheet 17 is disposed on the stack of the coil sheets 4, 5 and 6 so as to sandwich them between the insulating sheets 17 and 14. The insulating sheets 9, 10, 11, 14 and 17 have center windows 9a, 10a, 11a, 14a and 17a, respectively. Two core halves of, for example, ferrite, 18 and 19 are used. The core halves 18 and 19 have center legs 18a and 19a, respectively, with grooves 18b and 18c, and 19b and 19c located on opposite sides of the respective legs 18a and 19a. Outward of the grooves 18b and 18c are outer legs 18d and 18e, respectively, and outward of the grooves 19b and 19c are outer legs 19d and 19e, respectively. The core halves 18 and 19 are combined in such a manner that the center legs 18a and 19a can be placed to extend through the center windows 1a-6a in the coil sheets 1-6 and the center windows 9a-14a and 17a in the insulating sheets 9-14 and 17.

In manufacturing this transformer, work for stacking the metallic coil sheets and the insulating sheets alternately is necessary, which increases the cost of the transformer. Furthermore, with this arrangement, the metallic coil sheets are exposed to air and, therefore, may be oxidized and rust after long use. In addition, in order to fulfill safety standards for transformers, it must be so arranged that a sufficient creepage distance can be kept even when the insulating sheets 9, 10, 11, 14 and 17 are displaced more or less with respect to is the metallic coil sheets. For that purpose, larger insulating sheets must be used, which makes transformers larger in size.

An object of the present invention is to provide a coil that requires fewer steps in manufacturing it, is hardly oxidized and is small in size.

### SUMMARY OF THE INVENTION

A coil according to one embodiment of the present invention includes a coil section having a plurality of metallic coil sheets. The coil sheets are planar and each have a window in the center portion thereof. A slit is formed in each coil sheet, which extends from a location on the periphery of the window through the sheet to the outer periphery of the sheet. Connection terminals are formed on the sheet at locations facing each other across the slit. The coil sheets are stacked, and adjacent coil sheets are electrically connected with each other by the connection terminals. A core is disposed within the windows in the coil sheets. Each of the metallic coil sheets is individually coated completely with an insulating coating before the metallic coil sheets are stacked.

With the above-described arrangement, since each of the metallic coil sheet of the coil is individually pre-coated with an insulating coating, there is no need for placing an insulating sheet between adjacent coil sheets when the metallic coils sheets are stacked, which can reduce the manufacturing steps, which, in turn, can reduce the manufacturing cost. Furthermore, by covering the entire surface of each of the metallic coil sheets with an insulating coating, the metallic coil sheets are hardly oxidized and rusted. In addition, since each of the metallic sheets is individually pre-coated with an insulating coating, there is no need to take care to keep that insulating sheets are not displaced relative to the metallic coil sheets when the metallic coil sheets are stacked. Accordingly, it is not necessary to take such displacement into account when setting a creepage distance, and, therefore, the creepage distance can be set small. Then, the size of transformers can be reduced.

A plurality of coil sections may be used. The core is disposed to extend through the windows in the metallic coil sheets of the coil sections, so that the plural coil sections are inductively coupled with each other. This arrangement provides a transformer which can be manufactured at a low cost and hardly rust, and is small in size.

The insulating coatings may be formed by applying an insulative resin directly over the metallic coil sheet. Alternatively, an insulating film may be bonded to the metallic coil sheet to cover part of or the entirety of the surface of the metallic coil sheet before stacking the metallic coil sheets. The insulating resin may be used as an adhesive to bond the pre-formed insulating film to the metallic coil sheet.

### BRIEF DESCRIPTION OF THE DRAWINGS

FIG. 1 is an exploded perspective view of a prior art transformer.

FIG. 2 is an exploded perspective view of a transformer according to a first embodiment of the present invention.

FIGS. 3a, 3b, 3c and 3d illustrate steps for manufacturing a metallic coil sheet useable in the transformer shown in FIG. 2.

FIG. 4a is a plan view of a metallic coil sheet useable in the transformer of FIG. 2, FIG. 4b is a cross-sectional view of the metallic coil sheet shown in FIG. 4a along a line 4b-4b, and FIG. 4c is a cross-sectional view of the metallic coil sheet of FIG. 4a along a line 4c-4c.

FIG. 5a is a cross-sectional view of a metallic coil sheet useable in the transformer of FIG. 2, and FIG. 5b is a cross-sectional view of a metallic coil sheet used in a prior art transformer.

FIG. 6 is an exploded perspective view of a choke manufactured using a coil of the present invention.

### DESCRIPTION OF EMBODIMENTS

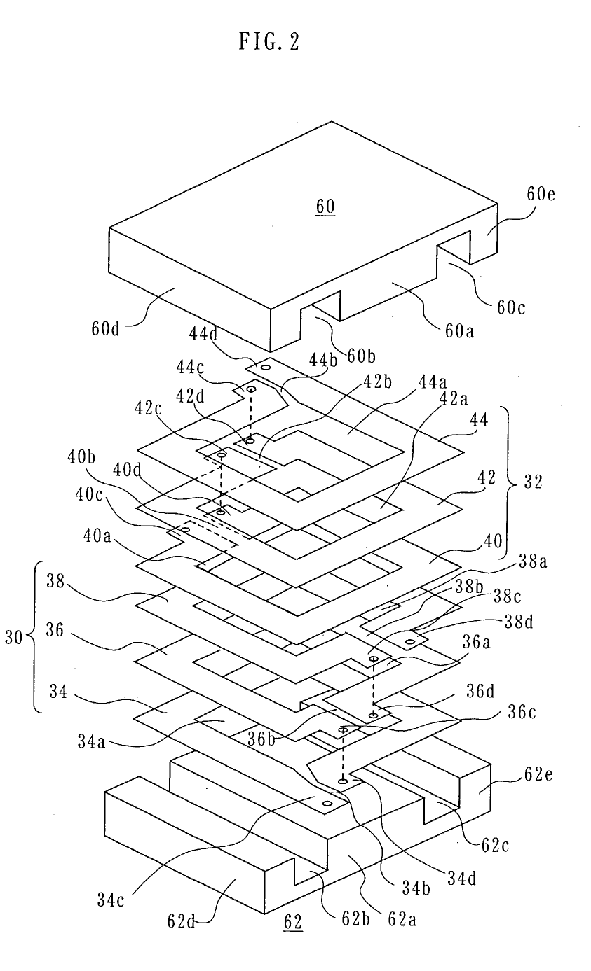

The present invention may be embodied in a high-frequency large current handling transformer, as shown in FIG. 2. The transformer includes a plurality, two, for example, of coil sections, or windings 30 and 32.

The winding 30 includes a plurality, three, for example, of metallic coil sheets 34, 36 and 38, which are formed in a rectangular shape and have the same size. The metallic coil sheets 34, 36 and 38 have windows 34a, 36a and 38a, respectively, in their center areas. The windows 34a, 36a and 38a have the same size. The metallic coil sheets 34, 36 and 38 are formed of metal, e.g. copper. Each of the coil sheets 34, 36 and 38 includes a slit 34b, 36b, 38b in one of the four sides around the window. The sides in which the slits are formed are on the same side of the completed transformer, but the locations of the slits 34b, 36b and 38b are offset with respect to each other. On the portions of the coil sheet 34 facing each other across the slit 34b, terminals 34c and 34d are provided. Similarly, terminals 36c and 36d and terminals 38c and 38d are provided on the portions of the coil sheets 36 and 38 facing each other across the respective slits 36b and 38b. The terminals 34c, 36c and 38c provide winding start terminals, and the terminals 34d, 36d and 38d provide winding end terminals. The metallic coil sheets 34, 36 and 38 are stacked up with the windows 34a, 36a and 38a therein aligned with each other. The locations of the slits 34b, 36b and 38 are determined such that, when the coil sheets are stacked, the terminals 34d and 36d are vertically aligned, and the terminals 36d and 38c are vertically aligned.

The winding 32 includes metallic coil sheets 40, 42 and 44 configured similarly to the metallic coil sheets 34, 36 and 38 of the winding 30. The metallic coil sheets 40, 42 and 44 have respective windows 40a, 42a and 44a, respective slits 40b, 42b and 44b, respective pairs of terminals 40c and 40d, 42c and 42d, and 44c and 44d. The metallic coil sheets 40, 42 and 44, too, are stacked in such a manner that the windows 40a, 42a and 44a therein are vertically aligned. The locations of the slits 40b, 42b and 44b are determined such that the terminals 40d and 42c can be vertically aligned and the terminals 42d and 44c can be vertically aligned when the metallic coil sheets 40, 42 and 44 are stacked.

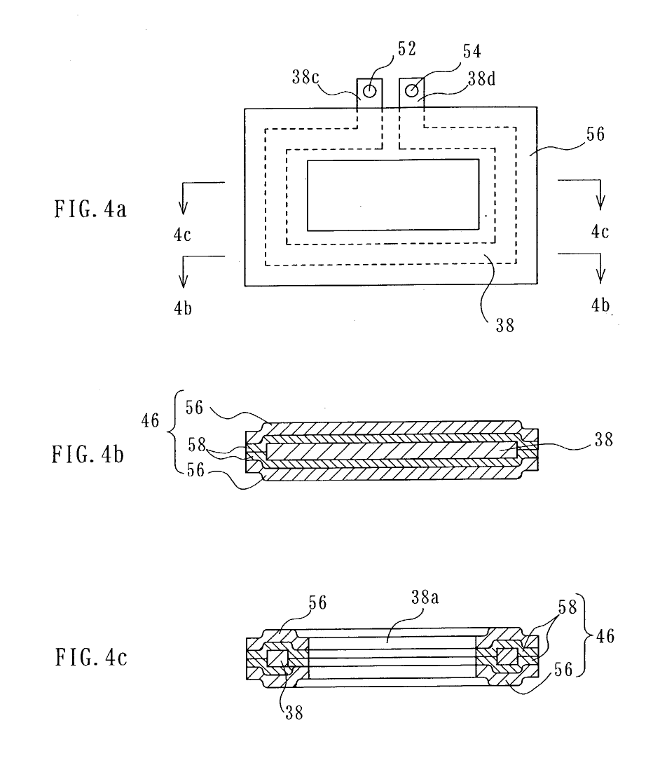

Each of the metallic coil sheets 34, 36, 38, 40, 42 and 44 has an insulating coating (46) thereon, as represented by the metallic coil sheet 38 shown in detail in FIGS. 4a, 4b and 4c. The insulating coating 46 covers the entire surface of the metallic coil sheet 38. FIG. 4b is a cross-sectional view of the metallic coil sheet 38 with the insulating coating shown in FIG. 4a along a line 4b-4b, and FIG. 4c is a cross-sectional view along a line 4c-4c.

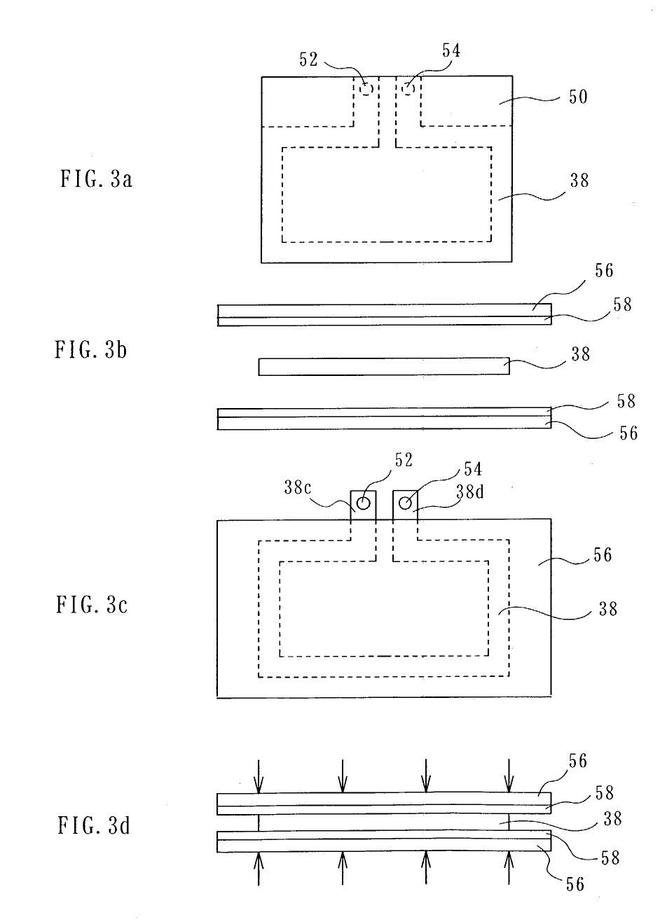

The insulating coating 46 is formed of an insulating film and an epoxy resin layer, and is formed in the following manner. First, the metallic coil sheet 38 is formed by punching a copper sheet 50 along broken lines, as shown in FIG. 3a. At this stage, holes 52 and 54 are also formed in the terminals 38c and 38d, respectively. Next, as shown in FIG. 3b, two insulating films, e.g. polyimide films 56 with an insulating adhesive layer, e.g. an epoxy resin layer 58, are prepared by applying epoxy resin over one surface of each polyimide film 56. The polyimide films 56 are rectangular and larger in size than the metallic coil sheet 38.

When the epoxy resin layers 58 are partly dried, the polyimide films 56 are joined to opposing two major surfaces of the metallic coil sheet 38, by placing, as shown in FIG. 3c, the epoxy resin layers 58 to contact with the major surfaces of the metallic coil sheet 38. Thus, the metallic coil sheet 38 is sandwiched. As is seen from FIG. 3c, the terminals 38c and 38d are not covered with the polyimide films 56.

Then, as shown in FIG. 3d, downward and upward pressures are applied to the polyimide films 56 joined to the metallic coil sheet 38, by means of a press (not shown), e.g. a press with silicone rubber pressing surfaces, and the metallic coil sheet 38 and the polyimide films 56 are heated at a temperature between about 150° C. and about 180° C. for a time period of from three (3) hours to five (5) hours, to thereby cure the epoxy resin 58. After that, unnecessary peripheral and center portions of the polyimide films 56 and epoixy resin layers 58 are punched and removed, which results in the metallic coil sheet 38 with the polyimide films 56, shown in FIG. 4a. The holes 52 and 54 in the terminals 38c and 38d are used in positioning the metallic coil sheet 38 for this punching step. The other metallic coil sheets are also provided with an insulating coating in the same manner as described above. It should be noted that the thickness of the polyimide films 56 and epoxy resin layers 58 is exaggerated in FIGS. 3a-3d and 4a-4c.

The metallic coil sheets 34, 36 and 38 with the respective insulating coatings formed in the manner described above are stacked in such a manner that the terminal 36c is placed on the terminal 34d and the terminal 38c is placed on the terminal 36d, whereby the winding 30 is formed. Similarly, the metallic coil sheets 40, 42 and 44 with the respective insulating coatings formed in the manner described above are stacked such that the terminal 42c is placed on the terminal 40d and the terminal 44c is placed on the terminal 42d, whereby the winding 32 is formed. The terminals 34d and 36c of the winding 30 are electrically connected together, and also, the terminals 36d and 38c are electrically connected. Similarly, the terminals 40d and 42c of the winding 32 are electrically connected together, and the terminals 42d and 44c are electrically connected together.

The two windings 30 and 32 are stacked in such a manner that the windows 34a, 36a, 38a, 40a, 42a and 44a are vertically aligned, and cores 60 and 62 of, for example, ferrite, are placed to sandwich the vertically stacked windings 30 and 32. More specifically, the upper core 60 has a center leg 60a, two outer legs 60d and 60e, and grooves 60b and 60c between the center leg 60a and the outer leg 60d and between the center leg 60a and the outer leg 60e, respectively. Similarly, the lower core 62 has a center leg 62a, two outer legs 62d and 62e, and grooves 62b and 62c between the center leg 62a and the outer leg 62d and between the center leg 62a and the outer leg 62e, respectively. The center legs 60a and 62a are adapted to be placed into the windows 34a, 36a, 38a, 40a, 42a and 44a, and two opposing sides of each metallic coil sheet 34, 36, 38, 40, 42 and 44 are placed in the respective spaces defined by the grooves 60b, 60c, 62b and 62c, when the cores 60 and 62 are placed over the stacked windings 30 and 32 from above and below the stack.

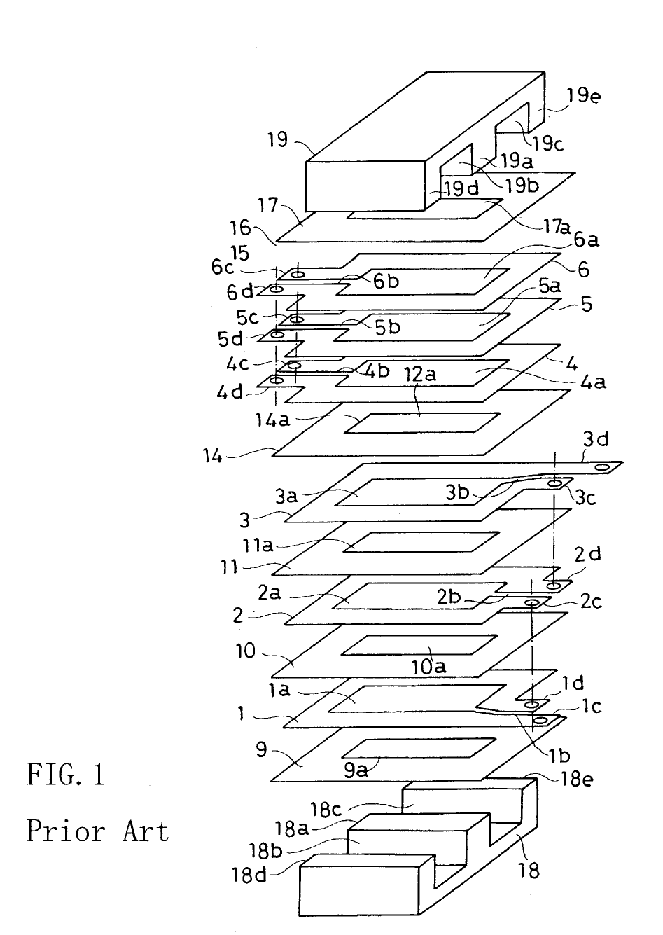

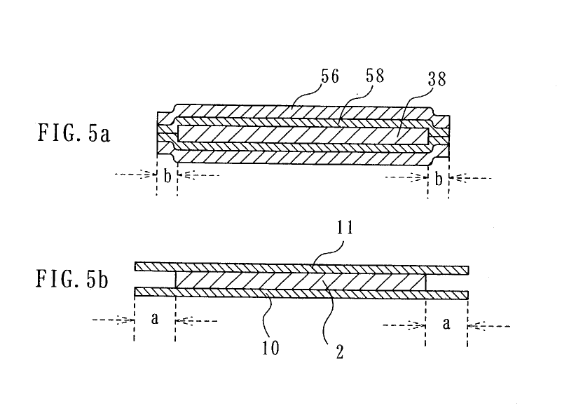

FIG. 5a is a cross-sectional view of the metallic coil sheet 38 provided with the insulating coating 46. FIG. 5b is a cross-sectional view of the prior art metallic coil sheet 2 (FIG. 1) which does not have an insulating coating like the coating 46, but is insulated by means of the insulating sheets 10 and 11, for example. The metallic coil sheets 38 and 2 have the same size. As is understood from FIG. 5b, the prior art metallic coil sheet 2 requires larger insulating sheets so as to provide a larger creepage distance “a” in order to secure its necessary creepage distance when the position of the coil sheet 2 relative to the insulating sheets 10 and 11 is deviates from the nominal position. In contrast, according to the present invention, as shown in FIG. 5a, since the metallic coil sheet 38 is joined with the insulating coating 46, the creepage distance “b” can be only what is required and need not be longer than required. Shorter creepage distance can make it possible to downsize the transformer. Furthermore, since the metallic coil sheets are individually covered with the insulating coatings 56, working to place an insulating sheet between adjacent metallic coil sheets can be eliminated, which reduces the manufacturing cost. In addition, the insulating coatings 56 entirely covering the individual metallic coil sheets 38 can prevent the sheets 38 from rusting.

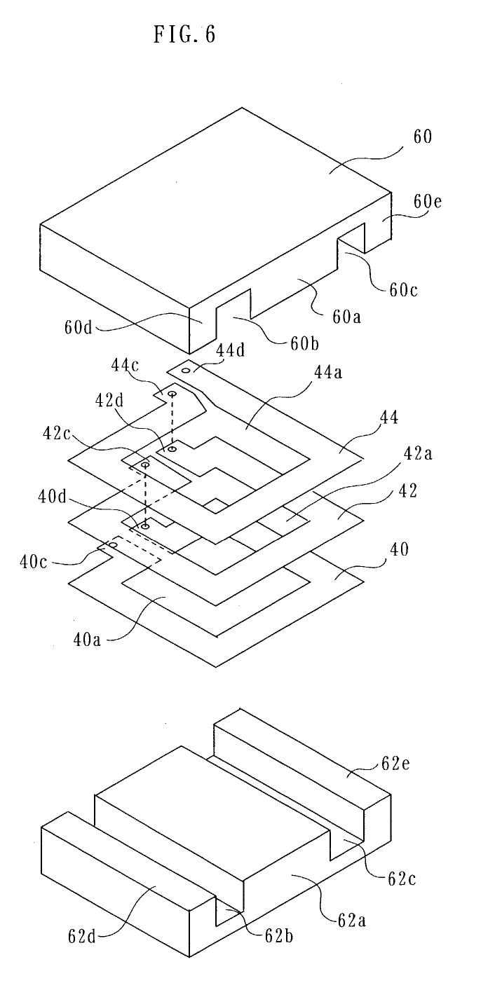

FIG. 6 shows a coil according to the present invention as used for forming a high-frequency choke. The structure of the high-frequency choke show is same as that of the transformer shown in FIG. 2 from which the coil 30 is removed. Therefore, the same reference numerals as used in FIG. 2 are used for equivalent portions, and detailed description of the choke is not given.

In place of the two windings 30 and 32 used for the transformer shown in FIG. 2, more windings may be used so that a transformer with one primary winding and a plurality of secondary windings may be formed. In place of polyimide and epoxy, other materials may be used for the insulating films and insulating adhesive.

What is claimed is:

1. A coil comprising:
a coil section including a plurality of metallic coil sheets, each of said metallic coil sheets being planar, and having a center window and a slit extending from said window to an outer edge of said sheet, said metallic coil sheets each having connection terminals at locations facing each other across said slit, said plurality of metallic coil sheets being stacked, with adjacent ones of said stacked metallic coil sheets electrically connected with each other by means of said connection terminals; and
a core disposed in said windows of said stacked metallic coil sheets;
wherein each of said metallic coil sheets is individually covered with an insulating coating before said metallic coil sheets are stacked.

2. A transformer comprising a plurality of coil sections as defined by claim 1, with said core disposed in said windows of said stacked metallic coil sheets of said plurality of coil sections.

3. The coil according to claim 1 wherein said insulating coating is a pre-formed insulating film.

4. The transformer according to claim 2 wherein said insulating coating is a pre-formed insulating film.

5. The coil according to claim 3 wherein said insulating film is bonded to said metallic coil sheet with an insulating resin.

6. The transformer according to claim 4 wherein said insulating film is bonded to said metallic coil sheet with an insulating resin.
